(19) United States
(12) Patent Application Publication
(10) Pub. No.: US 2026/0197546 A1
(43) Pub. Date: Jul. 9, 2026

(54) OPTICAL DEVICE AND OPTICAL SYSTEM

(71) Applicant: HTC Corporation, Taoyuan City (TW)

(72) Inventors: Chun-Yih WU, Taoyuan City (TW); Ta-Chun PU, Taoyuan City (TW); Yen-Liang KUO, Taoyuan City (TW)

(73) Assignee: HTC Corporation, Taoyuan City (TW)

(21) Appl. No.: 19/056,975

(22) Filed: Feb. 19, 2025

Related U.S. Application Data
(60) Provisional application No. 63/561,887, filed on Mar. 6, 2024.
(60) Provisional application No. 63/562,834, filed on Mar. 8, 2024.

(30) Foreign Application Priority Data
Jan. 3, 2025 (TW) 114100218

(51) Int. Cl. H04N 23/55; G02B 1/00

(52) U.S. Cl. CPC H04N 23/55; G02B 1/002

(57) ABSTRACT

An optical device includes a metamaterial lens element and an imager element. The metamaterial lens element includes a first light transformation layer and a second light transformation layer. The first light transformation layer includes a plurality of first dielectric units with a first refractive index, and a plurality of second dielectric units with a second refractive index. The first dielectric units are interleaved with the second dielectric units. The second light transformation layer is adjacent to the first light transformation layer. The second light transformation layer includes a plurality of third dielectric units with a third refractive index, and a plurality of fourth dielectric units with a fourth refractive index. The third dielectric units are interleaved with the fourth dielectric units. The metamaterial lens element is disposed on the imager element.

### CROSS REFERENCE TO RELATED APPLICATIONS

This application claims the benefit of U.S. Provisional Application No. 63/561,887, filed on Mar. 6, 2024, claims the benefit of U.S. Provisional Application No. 63/562,834, filed on Mar. 8, 2024, and also claims priority of Taiwan Patent Application No. 114100218 filed on Jan. 3, 2025, the entirety of which are incorporated by reference herein.

### BACKGROUND OF THE INVENTION

### Field of the Invention

The invention relates in general to an optical device, and more particularly, it relates to an optical device for use in the field of photographic technology.

### Description of the Related Art

In the technology used to design cameras, there must often be a trade-off between refractive index and dispersion when dealing with conventional optical materials. However, an optical material with a low refractive index also tends to limit the performance and design flexibility of the optical device in question. Accordingly, there is a need to propose a novel solution for solving the problem of the prior art.

### BRIEF SUMMARY OF THE INVENTION

In an exemplary embodiment, the invention is directed to an optical device that includes a metamaterial lens element and an imager element. The metamaterial lens element includes a first light transformation layer and a second light transformation layer. The first light transformation layer includes a plurality of first dielectric units with a first refractive index, and a plurality of second dielectric units with a second refractive index. The first dielectric units are interleaved with the second dielectric units. The second light transformation layer is adjacent to the first light transformation layer. The second light transformation layer includes a plurality of third dielectric units with a third refractive index, and a plurality of fourth dielectric units with a fourth refractive index. The third dielectric units are interleaved with the fourth dielectric units. The metamaterial lens element is disposed on the imager element.

In some embodiments, a visible light is transmitted through the metamaterial lens element to the imager element, the imager element generates an image signal.

In some embodiments, the first refractive index is greater than the second refractive index.

In some embodiments, the third refractive index is greater than the fourth refractive index.

In some embodiments, the second refractive index is smaller than the fourth refractive index.

In some embodiments, the third refractive index is equal to the first refractive index.

In some embodiments, the first light transformation layer is disposed on the second light transformation layer.

In some embodiments, the third dielectric units are substantially aligned with the second dielectric units, respectively.

In some embodiments, the fourth dielectric units are substantially aligned with the first dielectric units, respectively.

In some embodiments, the operational frequency of the optical device is from 120 THz to 790 THz.

In some embodiments, the thickness of the first light transformation layer is from 0.1 to 1 wavelength of the operational frequency.

In some embodiments, the length of each of the first dielectric units is from 0.1 to 1 wavelength of the operational frequency.

In some embodiments, the length of each of the second dielectric units is from 0.1 to 1 wavelength of the operational frequency.

In some embodiments, the thickness of the second light transformation layer is from 0.1 to 1 wavelength of the operational frequency.

In some embodiments, the length of each of the third dielectric units is from 0.1 to 1 wavelength of the operational frequency.

In some embodiments, the length of each of the fourth dielectric units is from 0.1 to 1 wavelength of the operational frequency.

In some embodiments, each of the first dielectric units substantially has a cube, a cuboid, a cylinder, or a polygonal prism.

In some embodiments, each of the third dielectric units substantially has a cube, a cuboid, a cylinder, or a polygonal prism.

In another exemplary embodiment, the invention is directed to an optical system that includes a plurality of metamaterial lens elements, at least one imager element, and a substrate. The metamaterial lens elements are disposed on the imager element. The substrate is configured to carry the metamaterial lens elements and the imager element. Each of the metamaterial lens elements includes a first light transformation layer and a second light transformation layer. The first light transformation layer includes a plurality of first dielectric units with a first refractive index, and a plurality of second dielectric units with a second refractive index. The first dielectric units are interleaved with the second dielectric units. The second light transformation layer is adjacent to the first light transformation layer. The second light transformation layer includes a plurality of third dielectric units with a third refractive index, and a plurality of fourth dielectric units with a fourth refractive index. The third dielectric units are interleaved with the fourth dielectric units.

In another exemplary embodiment, the invention is directed to an optical system that includes a first metamaterial lens element, a first imager element, a second metamaterial lens element, a second imager element, and a multilayer substrate. The first metamaterial lens element is disposed on the first imager element. The second metamaterial lens element is disposed on the second imager element. The multilayer substrate is configured to carry the first metamaterial lens element, the first imager element, the second metamaterial lens element, and the second imager element. Each of the first metamaterial lens element and the second metamaterial lens element includes a first light transformation layer and a second light transformation layer. The first light transformation layer includes a plurality of first dielectric units with a first refractive index, and a plurality of second dielectric units with a second refractive index. The first dielectric units are interleaved with the second dielectric units. The second light transformation layer is adjacent to the first light transformation layer. The second light transformation layer includes a plurality of third dielectric units with a third refractive index, and a plurality of fourth dielectric units with a fourth refractive index. The third dielectric units are interleaved with the fourth dielectric units.

### BRIEF DESCRIPTION OF DRAWINGS

The invention can be more fully understood by reading the subsequent detailed description and examples with references made to the accompanying drawings, wherein:

FIG. 1 is a sectional view of an optical device according to an embodiment of the invention;

FIG. 2 is a perspective view of a first light transformation layer according to an embodiment of the invention;

FIG. 3 is a perspective view of a first light transformation layer according to an embodiment of the invention;

FIG. 4 is a perspective view of a first light transformation layer according to an embodiment of the invention;

FIG. 5 is a sectional view of an optical system according to an embodiment of the invention; and

FIG. 6 is a sectional view of an optical system according to an embodiment of the invention.

### DETAILED DESCRIPTION OF THE INVENTION

In order to illustrate the foregoing and other purposes, features and advantages of the invention, the embodiments and figures of the invention will be described in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

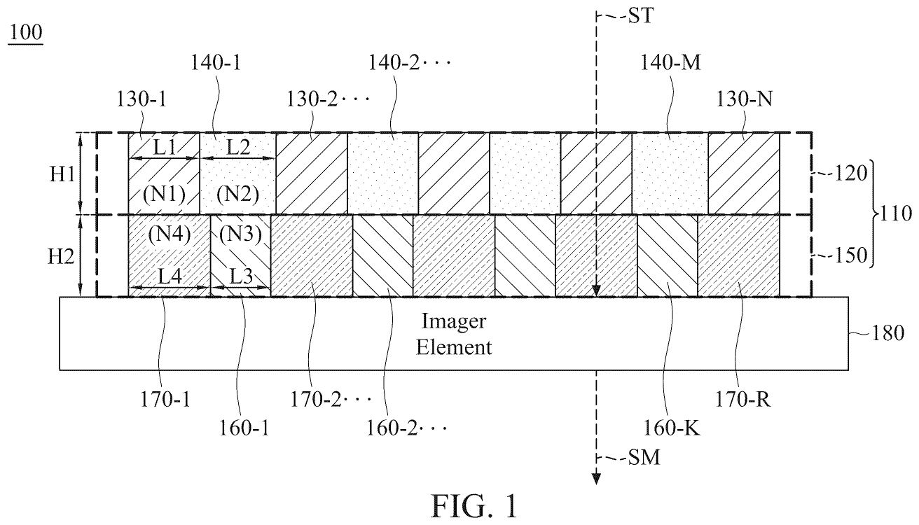

FIG. 1 is a sectional view of an optical device 100 according to an embodiment of the invention. The optical device 100 may be applied in a mobile device, such as a smart phone, a tablet computer, or a notebook computer. As shown in FIG. 1, the optical device 100 includes a metamaterial lens element 110 and an imager element 180. It should be understood that the optical device 100 may further include other components, such as a processor, a battery element, and/or a housing, although they are not displayed in FIG. 1.

The metamaterial lens element 110 includes a first light transformation layer 120 and a second light transformation layer 150. The second light transformation layer 150 is disposed adjacent to the first light transformation layer 120. It should be noted that the term “adjacent” or “close” over the disclosure means that the distance (spacing) between two corresponding elements is smaller than a predetermined distance (e.g., 10 mm or the shorter), or means that the two corresponding elements directly touch each other (i.e., the aforementioned distance/spacing between them is reduced to 0). In some embodiments, the first light transformation layer 120 is disposed on the second light transformation layer 150, and they are directly attached to each other. In alternative embodiments, the metamaterial lens element 110 includes more light transformation layers (not shown).

The first light transformation layer 120 is considered as a first periodic structure. Specifically, the first light transformation layer 120 includes a plurality of first dielectric units 130-1, 130-2, . . . , and 130-N and a plurality of second dielectric units 140-1, 140-2, . . . , and 140-M, where “N” and “M” may be integers greater than or equal to 3. In the first light transformation layer 120, the first dielectric units 130-1, 130-2, . . . , and 130-N may be interleaved with the second dielectric units 140-1, 140-2, . . . , and 140-M. In some embodiments, the first dielectric units 130-1, 130-2, . . . , and 130-N have a first refractive index N1, and the second dielectric units 140-1, 140-2, . . . , and 140-M have a second refractive index N2. The second refractive index N2 is different from the first refractive index N1. For example, the first refractive index N1 may be greater than the second refractive index N2, but they are not limited thereto.

The second light transformation layer 150 is considered as a second periodic structure. Specifically, the second light transformation layer 150 includes a plurality of third dielectric units 160-1, 160-2, . . . , and 160-K and a plurality of fourth dielectric units 170-1, 170-2, . . . , and 170-R, where “K” and “R” may be integers greater than or equal to 3. In the second light transformation layer 150, the third dielectric units 160-1, 160-2, . . . , and 160-K may be interleaved with the fourth dielectric units 170-1, 170-2, . . . , and 170-R. In some embodiments, the third dielectric units 160-1, 160-2, . . . , and 160-K have a third refractive index N3, and the fourth dielectric units 170-1, 170-2, . . . , and 170-R have a fourth refractive index N4. The fourth refractive index N4 is different from the third refractive index N3. For example, the third refractive index N3 may be greater than the fourth refractive index N4, but they are not limited thereto.

In some embodiments, the third dielectric units 160-1, 160-2, . . . , and 160-K of the second light transformation layer 150 are substantially aligned with the second dielectric units 140-1, 140-2, . . . , and 140-M of the first light transformation layer 120, respectively. It should be understood that the shapes and distributions of the second dielectric units 140-1, 140-2, . . . , and 140-M and the third dielectric units 160-1, 160-2, . . . , and 160-K are not limited in the invention.

In some embodiments, the fourth dielectric units 170-1, 170-2, . . . , and 170-R of the second light transformation layer 150 are substantially aligned with the first dielectric units 130-1, 130-2, . . . , and 130-N of the first light transformation layer 120, respectively. It should be understood that the shapes and distributions of the first dielectric units 130-1, 130-2, . . . , and 130-N and fourth dielectric units 170-1, 170-2, . . . , and 170-R are not limited in the invention.

For example, the imager element 180 may include an array composed of multiple CCDs (Charge-Coupled Devices) (not shown), but it is not limited thereto. The metamaterial lens element 110 is disposed on the imager element 180. Generally, when a visible light ST is transmitted through the metamaterial lens element 110 to the imager element 180, the imager element 180 can generate an image signal SM according to the visible light ST. Thus, the optical device 100 provides a camera function. According to practical measurements, the metamaterial lens element 110 has a sufficient equivalent refractive index for fine-tuning the direction and phase of the visible light ST. The overall size of the optical device 100 using the metamaterial lens element 110 can be significantly reduced due to the metamaterial lens element 110's characteristics of thinness and lightness. In addition, because the metamaterial lens element 110 does not include any metal element, its energy loss can be almost negligible.

In some embodiments, the operational frequency of the optical device 100 is from 120 THz to 790 THz. Furthermore, the frequency of the visible light ST also falls within the aforementioned range of the operational frequency of the optical device 100.

In some embodiments, the element sizes and element parameters of the optical device 100 will be described as follows. The thickness H1 of the first light transformation layer 120 may be from 0.1 to 1 wavelength (λ/10~1λ) of the operational frequency of the optical device 100. The length L1 of each of the first dielectric units 130-1, 130-2, . . . , and 130-N may be from 0.1 to 1 wavelength (λ/10~1λ) of the operational frequency of the optical device 100. The length L2 of each of the second dielectric units 140-1, 140-2, . . . , and 140-M may be from 0.1 to 1 wavelength (λ/10~1λ) of the operational frequency of the optical device 100, such as about 0.25 wavelength (λ/4). The thickness H2 of the second light transformation layer 150 may be from 0.1 to 1 wavelength (λ/10~1λ) of the operational frequency of the optical device 100. The length L3 of each of the third dielectric units 160-1, 160-2, . . . , and 160-K may be from 0.1 to 1 wavelength (λ/10~1λ) of the operational frequency of the optical device 100. The length L4 of each of the fourth dielectric units 170-1, 170-2, . . . , and 170-R may be from 0.1 to 1 wavelength (λ/10~1λ) of the operational frequency of the optical device 100, such as about 0.25 wavelength (λ/4). The second refractive index N2 may be smaller than the fourth refractive index N4. The third refractive index N3 may be equal to the first refractive index N1. The above ranges of element sizes and element parameters are calculated and obtained according to many experimental results, and they help to maximize the equivalent refractive index of the optical device 100 and also to minimize the overall size of the optical device 100.

In some embodiments, the material of any of the first dielectric units 130-1, 130-2, . . . , and 130-N, the second dielectric units 140-1, 140-2, . . . , and 140-M, the third dielectric units 160-1, 160-2, . . . , and 160-K, and the fourth dielectric units 170-1, 170-2, . . . , and 170-R is selected among the following elements or compounds: gallium nitride (GaN), silicon (Si), germanium (Ge), cadmium selenide (CdSe), zinc sulfide (ZnS), silicon dioxide (SiO₂), aluminum oxide (Al₂O₃), and silicon nitride (Si₃N₄). The refractive index of gallium nitride may be about 2.4. The refractive index of silicon may be about 3.5. The refractive index of germanium may be about 4. The refractive index of cadmium selenide may be about 2.5. The refractive index of zinc sulfide may be about 2.3. The refractive index of silicon dioxide may be about 1.45. The refractive index of aluminum oxide may be about 1.76. The refractive index of silicon nitride may be about 2.

In some embodiments, the first dielectric units 130-1, 130-2, . . . , and 130-N are made of gallium nitride materials, the second dielectric units 140-1, 140-2, . . . , and 140-M are a plurality of gaps (which may be filled with air), the third dielectric units 160-1, 160-2, . . . , and 160-K are also made of gallium nitride materials, and the fourth dielectric units 170-1, 170-2, . . . , and 170-R are made of silicon dioxide materials. According to practical measurements, such a design can help to suppress the non-ideal chromatic aberrations of the optical device 100.

The following embodiments will introduce different configurations and detail structural features of the optical device 100. It should be understood that these figures and descriptions are merely exemplary, rather than limitations of the invention.

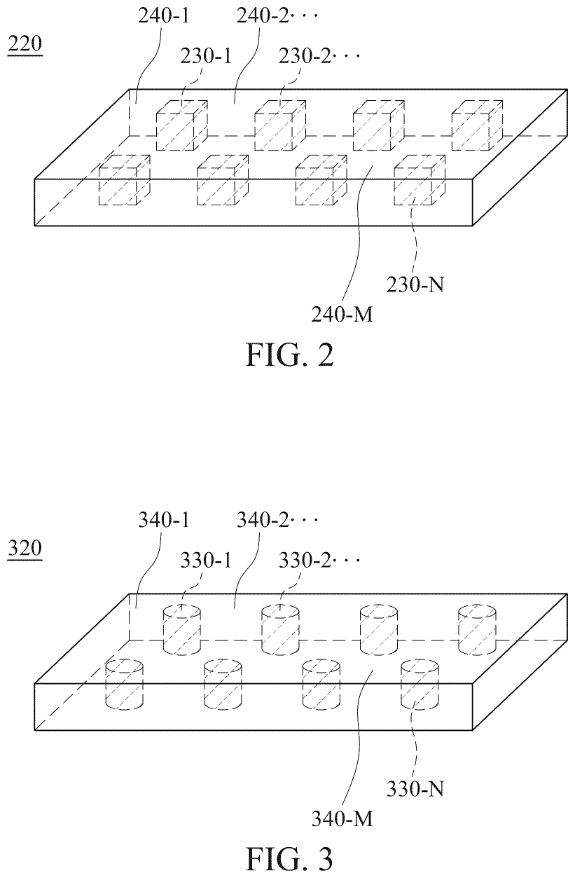

FIG. 2 is a perspective view of a first light transformation layer 220 according to an embodiment of the invention. The first light transformation layer 220 may be applied to the aforementioned optical device 100, and it can provide similar performance. In the embodiment of FIG. 2, the first light transformation layer 220 includes a plurality of first dielectric units 230-1, 230-2, . . . , and 230-N and a plurality of second dielectric units 240-1, 240-2, . . . , and 240-M. The second dielectric units 240-1, 240-2, . . . , and 240-M are connected to each other. The first dielectric units 230-1, 230-2, . . . , and 230-N are periodically embedded in the second dielectric units 240-1, 240-2, . . . , and 240-M. For example, each of the first dielectric units 230-1, 230-2, . . . , and 230-N may substantially have a cube or a cuboid. In alternative embodiments, FIG. 2 is used to describe a structure of a second light transformation layer, and each of a plurality of third dielectric units of the second light transformation layer substantially has a cube or a cuboid.

FIG. 3 is a perspective view of a first light transformation layer 320 according to an embodiment of the invention. The first light transformation layer 320 may be applied to the aforementioned optical device 100, and it can provide similar performance. In the embodiment of FIG. 3, the first light transformation layer 320 includes a plurality of first dielectric units 330-1, 330-2, . . . , and 330-N and a plurality of second dielectric units 340-1, 340-2, . . . , and 340-M. The second dielectric units 340-1, 340-2, . . . , and 340-M are connected to each other. The first dielectric units 330-1, 330-2, . . . , and 330-N are periodically embedded in the second dielectric units 340-1, 340-2, . . . , and 340-M. For example, each of the first dielectric units 330-1, 330-2, . . . , and 330-N may substantially have a cylinder. In alternative embodiments, FIG. 3 is used to describe a structure of a second light transformation layer, and each of a plurality of third dielectric units of the second light transformation layer substantially has a cylinder.

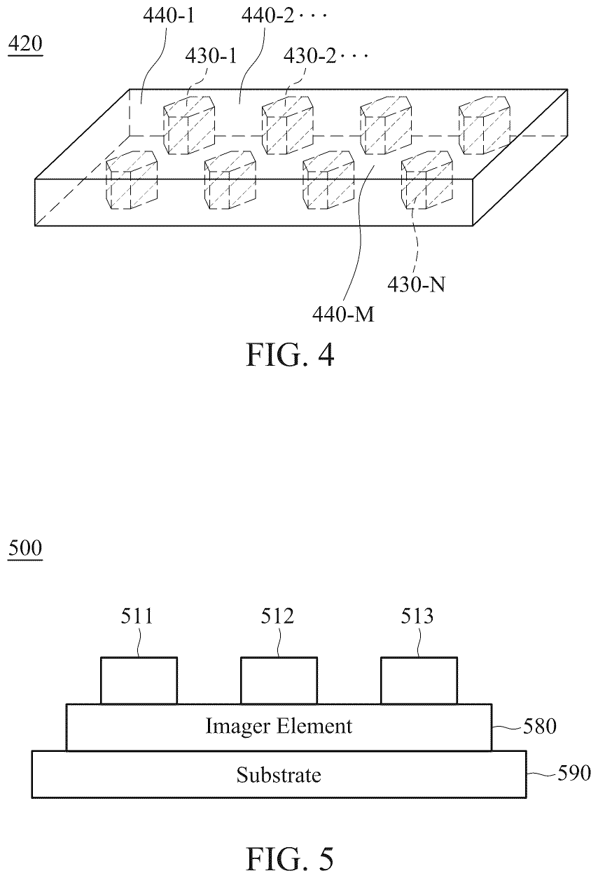

FIG. 4 is a perspective view of a first light transformation layer 420 according to an embodiment of the invention. The first light transformation layer 420 may be applied to the aforementioned optical device 100, and it can provide similar performance. In the embodiment of FIG. 4, the first light transformation layer 420 includes a plurality of first dielectric units 430-1, 430-2, . . . , and 430-N and a plurality of second dielectric units 440-1, 440-2, . . . , and 440-M. The second dielectric units 440-1, 440-2, . . . , and 440-M are connected to each other. The first dielectric units 430-1, 430-2, . . . , and 430-N are periodically embedded in the second dielectric units 440-1, 440-2, . . . , and 440-M. For example, each of the first dielectric units 430-1, 430-2, . . . , and 430-N may substantially have a polygonal prism. In alternative embodiments, FIG. 4 is used to describe a structure of a second light transformation layer, and each of a plurality of third dielectric units of the second light transformation layer substantially has a polygonal prism.

FIG. 5 is a sectional view of an optical system 500 according to an embodiment of the invention. FIG. 5 is similar to FIG. 1. In the embodiment of FIG. 5, the optical system 500 includes a plurality of metamaterial lens elements 511, 512 and 513, at least one imager element 580, and a substrate 590. The detailed structure of each of the metamaterial lens elements 511, 512 and 513 has been described in the previous embodiments, and it will not be illustrated again herein. The metamaterial lens elements 511, 512 and 513 are disposed on the imager element 580. The substrate 590 is configured to carry the metamaterial lens elements 511, 512 and 513 and the imager element 580. In alternative embodiments, the optical system 500 include more metamaterial lens elements, and more imager elements corresponding to these metamaterial lens elements. It should be understood that the metamaterial lens elements 511, 512 and 513 are configured as different regions of the optical system 500, and their equivalent refractive indexes are adjustable according to different requirements. Other features of the optical system 500 of FIG. 5 are similar to those of the optical device 100 of FIG. 1. Accordingly, the two embodiments can achieve similar levels of performance.

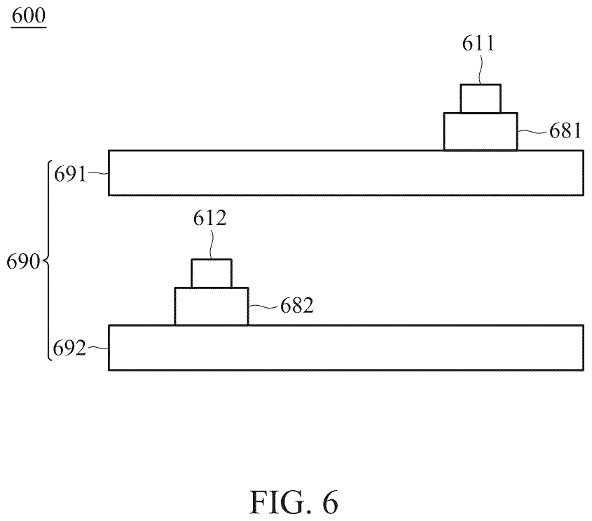

FIG. 6 is a sectional view of an optical system 600 according to an embodiment of the invention. FIG. 6 is similar to FIG. 1. In the embodiment of FIG. 6, the optical system 600 includes a first metamaterial lens element 611, a second metamaterial lens element 612, a first imager element 681, a second imager element 682, and a multilayer substrate 690. The detailed structure of each of the first metamaterial lens element 611 and the second metamaterial lens element 612 has been described in the previous embodiments, and it will not be illustrated again herein. The first metamaterial lens element 611 is disposed on the first imager element 681. The second metamaterial lens element 612 is disposed on the second imager element 682. The multilayer substrate 690 at least includes a first layer 691 and a second layer 692 which are parallel to each other. The first layer 691 is configured to carry the first metamaterial lens element 611 and the first imager element 681. The second layer 692 is configured to carry the second metamaterial lens element 612 and the second imager element 682. In alternative embodiments, the optical system 600 further includes more metamaterial lens elements and more imager elements, which are carried by different layers of the multilayer substrate 690. It should be understood that the first metamaterial lens element 611 and the second metamaterial lens element 612 are configured as different regions of the optical system 600, and their equivalent refractive indexes are adjustable according to different requirements. In addition, the design flexibility of the optical system 600 can be further improved by using the multilayer substrate 690. Other features of the optical system 600 of FIG. 6 are similar to those of the optical device 100 of FIG. 1. Accordingly, the two embodiments can achieve similar levels of performance.

The invention proposed an optical device and an optical system. In comparison to the conventional design, the invention has at least the advantages of reducing the overall size and increasing the equivalent refractive index. Therefore, the invention is suitable for application in a variety of devices.

Note that the above element sizes and element parameters are not limitations of the invention. A designer can fine-tune these setting values according to different requirements. It should be understood that the optical device and the optical system of the invention are not limited to the configurations of FIGS. 1-6. The invention may include any one or more features of any one or more embodiments of FIGS. 1-6. In other words, not all of the features displayed in the figures should be implemented in the optical device and the optical system of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

It will be apparent to those skilled in the art that various modifications and variations can be made in the invention. It is intended that the standard and examples be considered as exemplary only, with a true scope of the disclosed embodiments being indicated by the following claims and their equivalents.

What is claimed is:

1. An optical device, comprising:
a metamaterial lens element, comprising:
a first light transformation layer, comprising a plurality of first dielectric units with a first refractive index and a plurality of second dielectric units with a second refractive index, wherein the first dielectric units are interleaved with the second dielectric units; and
a second light transformation layer, disposed adjacent to the first light transformation layer, and comprising a plurality of third dielectric units with a third refractive index and a plurality of fourth dielectric units with a fourth refractive index, wherein the third dielectric units are interleaved with the fourth dielectric units; and
an imager element, wherein the metamaterial lens element is disposed on the imager element.

2. The optical device as claimed in claim 1, wherein when a visible light is transmitted through the metamaterial lens element to the imager element, the imager element generates an image signal.

3. The optical device as claimed in claim 1, wherein the first refractive index is greater than the second refractive index.

4. The optical device as claimed in claim 1, wherein the third refractive index is greater than the fourth refractive index.

5. The optical device as claimed in claim 1, wherein the second refractive index is smaller than the fourth refractive index.

6. The optical device as claimed in claim 1, wherein the third refractive index is equal to the first refractive index.

7. The optical device as claimed in claim 1, wherein the first light transformation layer is disposed on the second light transformation layer.

8. The optical device as claimed in claim 1, wherein the third dielectric units are substantially aligned with the second dielectric units, respectively.

9. The optical device as claimed in claim 1, wherein the fourth dielectric units are substantially aligned with the first dielectric units, respectively.

10. The optical device as claimed in claim 1, wherein an operational frequency of the optical device is from 120 THz to 790 THz.

11. The optical device as claimed in claim 10, wherein a thickness of the first light transformation layer is from 0.1 to 1 wavelength of the operational frequency.

12. The optical device as claimed in claim 10, wherein a length of each of the first dielectric units is from 0.1 to 1 wavelength of the operational frequency.

13. The optical device as claimed in claim 10, wherein a length of each of the second dielectric units is from 0.1 to 1 wavelength of the operational frequency.

14. The optical device as claimed in claim 10, wherein a thickness of the second light transformation layer is from 0.1 to 1 wavelength of the operational frequency.

15. The optical device as claimed in claim 10, wherein a length of each of the third dielectric units is from 0.1 to 1 wavelength of the operational frequency.

16. The optical device as claimed in claim 10, wherein a length of each of the fourth dielectric units is from 0.1 to 1 wavelength of the operational frequency.

17. The optical device as claimed in claim 1, wherein each of the first dielectric units substantially has a cube, a cuboid, a cylinder, or a polygonal prism.

18. The optical device as claimed in claim 1, wherein each of the third dielectric units substantially has a cube, a cuboid, a cylinder, or a polygonal prism.

19. An optical system, comprising:
a plurality of metamaterial lens elements;
at least one imager element, wherein the metamaterial lens elements are disposed on the imager element; and
a substrate, carrying the metamaterial lens elements and the imager element, wherein each of the metamaterial lens elements comprises:
a first light transformation layer, comprising a plurality of first dielectric units with a first refractive index and a plurality of second dielectric units with a second refractive index, wherein the first dielectric units are interleaved with the second dielectric units; and
a second light transformation layer, disposed adjacent to the first light transformation layer, and comprising a plurality of third dielectric units with a third refractive index and a plurality of fourth dielectric units with a fourth refractive index, wherein the third dielectric units are interleaved with the fourth dielectric units.

20. An optical system, comprising:
a first metamaterial lens element;
a first imager element, wherein the first metamaterial lens element is disposed on the first imager element;
a second metamaterial lens element;
a second imager element, wherein the second metamaterial lens element is disposed on the second imager element; and
a multilayer substrate, carrying the first metamaterial lens element, the first imager element, the second metamaterial lens element, and the second imager element, wherein each of the first metamaterial lens element and the second metamaterial lens element comprises:
a first light transformation layer, comprising a plurality of first dielectric units with a first refractive index and a plurality of second dielectric units with a second refractive index, wherein the first dielectric units are interleaved with the second dielectric units; and
a second light transformation layer, disposed adjacent to the first light transformation layer, and comprising a plurality of third dielectric units with a third refractive index and a plurality of fourth dielectric units with a fourth refractive index, wherein the third dielectric units are interleaved with the fourth dielectric units.
